(19) United States
(12) Patent Application Publication
(10) Pub. No.: US 2013/0282470 A1
(43) Pub. Date: Oct. 24, 2013

(54) SYSTEM AND METHOD FOR PROVIDING REAL-TIME LOYALTY DISCOUNTS AND PAPERLESS RECEIPTS

(71) Applicants: Aron SCHWARZKOPF, Boston, MA (US); Sebastian CASTRO, Boston, MA (US)

(72) Inventors: Aron SCHWARZKOPF, Boston, MA (US); Sebastian CASTRO, Boston, MA (US)

(73) Assignee: LEAF HOLDINGS, INC., Cambridge, MA (US)

(21) Appl. No.: 13/793,061

(22) Filed: Mar. 11, 2013

Related U.S. Application Data
(60) Provisional application No. 61/637,490, filed on Apr. 24, 2012.

(51) Int. Cl. G06Q 40/00

(52) U.S. Cl. CPC G06Q 40/10; G06Q 30/0233
USPC 705/14.33; 705/30; 705/14.27

(57) ABSTRACT

Systems and methods for transaction-based recordation of a new payment identifier. A payment identifier and a first user account associated with the payment identifier are received, the payment identifier and the first user account associated with a transaction. A user status associated with a user of the first user account is determined. A record is generated that includes the payment identifier, the first user account, and the user status. The record is recorded for use with subsequent transactions by the user.

### CROSS REFERENCE TO RELATED APPLICATIONS

This application claims priority to and the benefit of U.S. Provisional Application No. 61/637,490, filed Apr. 24, 2012, entitled, “System and Method for Real-Time Loyalty Rewards,” the disclosure of which is hereby incorporated by reference in its entirety.

### BACKGROUND

Embodiments described herein relate generally to methods and systems for facilitating delivery of paperless receipts that include discount information. Retaining customers (also referred to herein as “users”) is of enormous value to merchants, and retaining repeat customers in particular, provides significant benefits in times of crowded retail offerings. Retaining existing customers is typically easier than acquiring new customers, and existing customers often provide “word of mouth” marketing to potential new customers at little or no cost to the merchant. Rewarding repeat customers is increasingly commonplace and achieved by merchants via a variety of means including, for example, merchant-specific credit cards, rewards programs, coupons, and/or the like. Most existing reward programs, however, require the customer to be identifiable to the merchant during purchase as a repeat customer by, for example, presenting a discount and/or reward card provided by the merchant, using a merchant-specific credit card, presenting a coupon (electronic or paper), presenting a past receipt that includes the discount information, and so on. Many of these identification methods such and carrying around reward cards from numerous merchants and retaining receipts or coupons for prolonged periods of time can be overly burdensome on the customers. However, if a customer is willing to be mindful of these identification items, it can affect her merchant selection and she will typically favor the merchant that provides the best reward(s) for repeat business, i.e., for being “loyal.”

Therefore, there is a need for an end-to-end, transaction-to-receipt approach that recognizes and rewards customers without requiring them to carry reward cards and/or other discount information in this ever increasing digital world. There is also a need for a system that communicates the purchase information (e.g. a receipt), the applied reward information, and/or the earned reward information to a digital account of the user.

### SUMMARY

Systems and methods of generating and delivering paperless receipts are described herein. In some embodiments, a method of transaction-based recordation of a new payment identifier includes receiving a payment identifier and a first user account associated with the payment identifier. The payment identifier and the first user account are associated with a transaction. The method also includes determining a user status based on the first user account, where the user status is associated with a user of the first user account. The method further includes generating a record including the payment identifier, the first user account, and the user status, and recording the second record for use with subsequent transactions by the user.

In some embodiments, a method of providing a recorded user account with a paperless receipt includes receiving a payment identifier and a first user account associated with said payment identifier, where the payment identifier and the first user account are associated with a transaction. The method also includes determining a user status as a function of the first user account, where the user status is associated with a user of the first user account. The method further includes generating a second record including the payment identifier, the first user account, and the user status, and recording the second record for use with subsequent transactions by the user. The method also includes generating a paperless receipt of the transaction as a function of the user status of the user, and transmitting the paperless receipt to the first user account or a second user account of the user as a function of the user status of the user.

In some embodiments, a method of transaction-based recordation of discount information for a recorded user account includes receiving a payment identifier and a first user account associated with the payment identifier. The payment identifier and the first user account are associated with a current transaction. The method also includes determining a user status as a function of the first user account, where the user status is associated with a user of the first user account. The method additionally includes determining discount information as a function of the current transaction, and updating one or more records including the first user account with the discount information for use in one or more subsequent transactions by the user.

### BRIEF DESCRIPTION OF THE DRAWINGS

FIG. 1 is a flowchart of a method of the invention, according to an embodiment.

FIG. 2 is a system of the invention, according to an embodiment.

FIG. 3 is a schematic illustration of the payment system of FIG. 2, according to an embodiment.

FIG. 4 is a schematic illustration of the receipt system of FIG. 2, according to an embodiment.

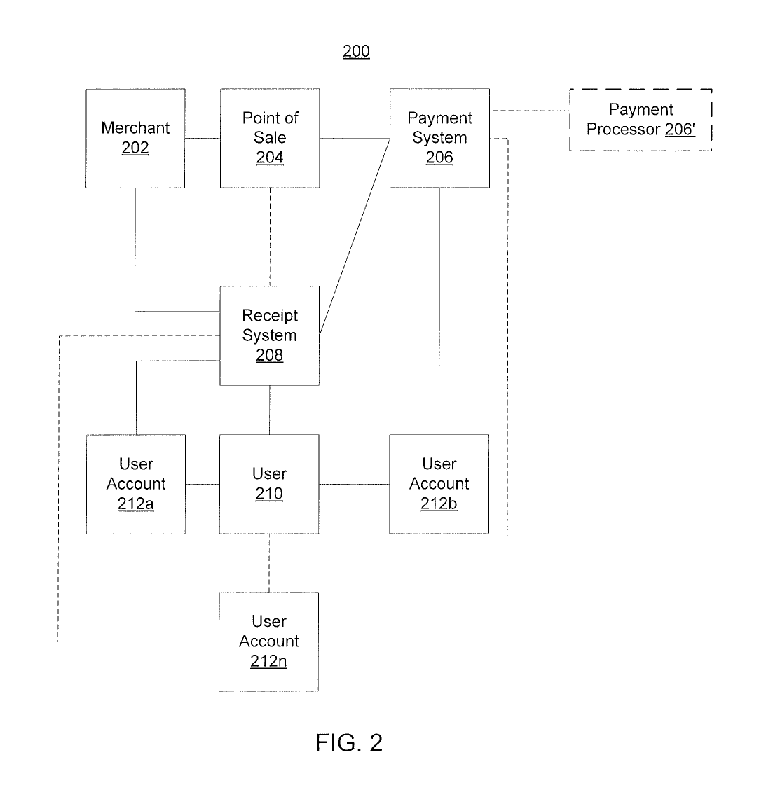

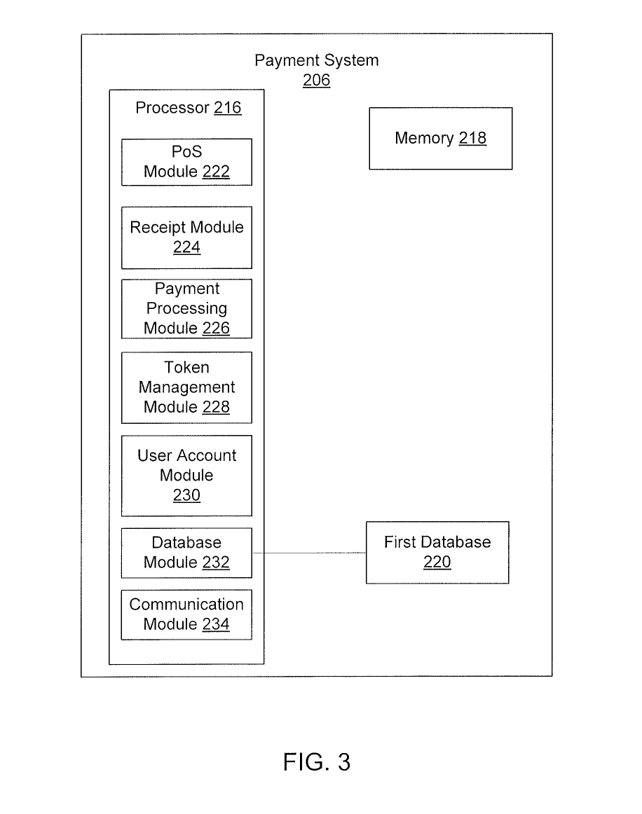

FIG. 3 is a schematic illustration of the payment system of FIG. 2, according to an embodiment.

FIG. 5 is a flowchart of a method of transaction-based recordation of a new payment identifier, according to an embodiment.

FIG. 6 is a flowchart of a method of providing a recorded user account with a paperless receipt, according to an embodiment.

FIG. 7 is a flowchart of a method of transaction-based recordation of discount information for a recorded user account, according to an embodiment.

### DETAILED DESCRIPTION

As used in this specification, the singular forms “a,” “an” and “the” include plural referents unless the context clearly dictates otherwise. Thus, for example, the term “a network” is intended to mean a single network or a combination of networks.

Methods and systems for issuing paperless receipts of transactions that incorporate loyalty discount information are described herein. Aspects of the invention enable customers (also interchangeably referred to as ‘users’) to provide registration information for receiving paperless receipts at, for example, registered social media accounts, and for receiving loyalty discounts. In some embodiments, a user can still receive a paperless receipt at a recorded account and/or a loyalty discount for a transaction without registration. Aspects of the invention also enable merchants to provide merchant information that can be used to determine loyalty discounts for transactions.

Loyalty programs typically require user identification at some point during the transaction, such as during checkout/payment. It is generally desirable that such identification is minimally burdensome on the user. Approaches that require the user to carry and/or remember merchant-specific information (such as a loyalty card, as is commonly issued by grocery stores) can be overly burdensome since the user has to carry separate loyalty cards for each individual merchant they frequent. Other approaches require the user to use the same payment means (e.g. the same credit card) for each transaction, which is additionally burdensome given the variety of payment options available to users, and which a merchant should be able to accept as part of quality customer service. In such a scenario, a customer could potentially end up with multiple accounts with the merchant, each corresponding to the same or a different payment means used by the user, with no consolidation of the loyalty benefits across the multiple accounts. If the user fails to provide any identification, she cannot avail of the discount, and cannot apply the transaction towards future discounts.

Yet other approaches require the user to enter specific identification information such as a telephone number that uniquely identifies the user. While telephone numbers are good candidates for unique identification and are easily remembered by their associated users, this approach too requires the user to perform the additional step of telephone number entry for every transaction, irrespective of whether the user is new or a repeat user.

Customers generally prefer the freedom to employ any of a variety of traditional and new payment methods that include credit/debit/gift cards, bank-based payments such as direct debit, bank transfer, real-time bank transfer based on online banking, contactless mobile payments (e.g. via SMS, direct mobile billing, geo-fencing, quick response codes, near field communication or NFC, audio signals, and so on), virtual currency (e.g. as associated with social media, virtual worlds, online gaming, and/or other online accounts), and/or the like.

Furthermore, when a user wants a digital receipt of the transaction, under current approaches she has to provide digital account information (such as an email address, or social media account credentials) for every transaction irrespective of whether the user is new or a repeat user, which has deficiencies similar to those described above.

Accordingly, embodiments described herein permit recognition of users during payment for a transaction, application of a loyalty discount associated with the user, and delivery of a paperless receipt to one or more digital accounts of the registered user. In some embodiments, the user is registered or is a repeat user pending registration (also referred to as a ‘pending user’), and provides no additional identifying information during the transaction other than standard payment information (e.g. swipes a credit card at a point-of-sale device). From a user standpoint, this approach cures deficiencies of other systems and methods that require even registered users to present additional information for identification (such as a merchant loyalty card or a telephone number), for receiving loyalty discounts (such as a paper coupon, or a digital coupon on their Smartphone), and for receiving digital receipts (such as an email account). For example, in some embodiments, a registered user can pay for the transaction with any credit card used for any previous transaction. The user will be identified as registered, a loyalty discount will be instantly applied to the user's purchase no matter which credit card is employed, and a digital receipt will be sent to a digital account associated with the registered user's profile.

In some embodiments, certain features described herein are driven by the occurrence of a transaction, and particularly by payment information provided for the transaction. In other words, the determination of whether a user is new, pending registration, or registered starts with the payment information provided per a standard checkout procedure. If the payment information is not new to the system, no further user identification is required (as further described in detail below). The payment information can include, but is not limited to, credit/debit/gift cards, bank-based payments such as direct debit, bank transfer, real-time bank transfer based on online banking, contactless mobile payments (e.g. via SMS, direct mobile billing, geo-fencing, quick response codes, near field communication or NFC, audio signals, and so on), virtual currency (e.g. as associated with social media, virtual worlds, online gaming, and/or other online accounts), and/or the like. The payment information can be provided via any suitable means, such as a point-of-sale (PoS) device, another NFC device, and/or the like. In some embodiments, the payment information is received at a point-of-sale system as described in U.S. patent application Ser. No. 13/342,492, filed Jan. 3, 2012, entitled “Apparatus and Systems of a Computerized Bill Presenter System,” the entire disclosure of which is incorporated herein by reference. In some embodiments, and as explained in more detail below, the PoS is configurable to present discount information to a user, and can be further configurable to receive user input accepting or rejecting the application of the discount information to the payment information.

In some embodiments, a unique payment identifier is generated as a function of the payment information for further electronic transactions. In some embodiments, the payment information includes a credit or debit card number, and the payment identifier is a token generated by the point-of-sale device that is Payment Card Industry (PCI) compliant, and can be a 16-digit randomly generated number, the first four digits of which can be the same as the last four digits of the card number. Unless specified otherwise, the payment identifier also refers to the associated payment means (e.g. a credit card and its associated credit card number).

Determining whether a payment identifier is new or preexisting can be performed by reviewing records of previously used payment identifiers. In some embodiments, aspects of the invention include a first database having records of previously used payment identifiers. Accordingly, a payment identifier is preexisting if it is found in any record in the first database, and is new otherwise.

In some embodiments, if the payment identifier is new and the user does not desire a paperless receipt, the payment identifier is discarded. In other words, no record is created in the first database that includes the payment identifier.

Once it is ascertained whether the payment identifier is new or preexisting, delivery of paperless receipts and application of loyalty discounts is determined based on additional factors including, but not limited to, whether the user requests a paperless receipt, whether the user status of the user is new/pending/registered, and/or the like. In some embodiments, a second database of records of payment identifiers, each record also including a user status, is queried. Accordingly, a user is new if no record of the payment identifier is found in any record in the second database, is pending if at least one record of the payment identifier specifies the user status as pending, and is registered if at least one record of the payment identifier specifies the user status as registered.

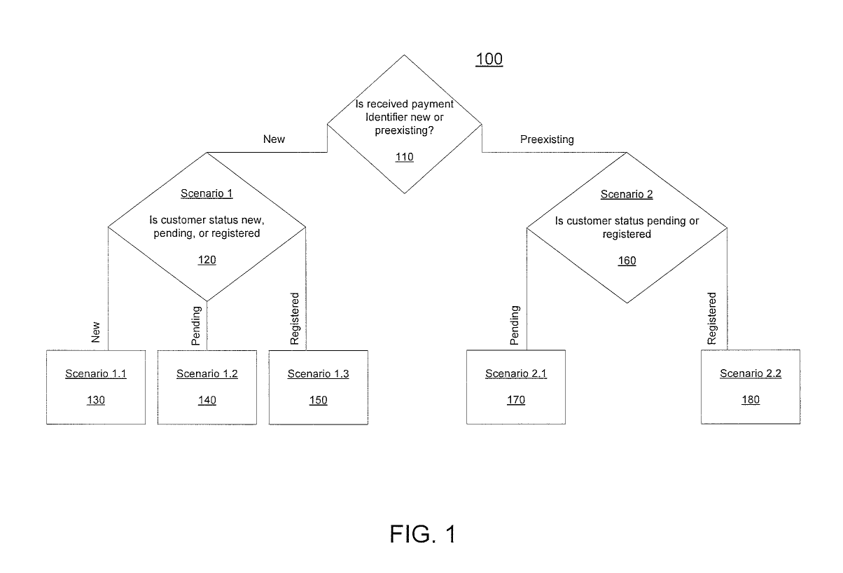

For ease of explanation, various embodiments will now be described based on the scenarios described below: when the payment identifier is new and the user desires a paperless receipt (scenario 1), and when the payment information is preexisting (scenario 2). FIG. 1 illustrates a method 100 according to embodiments, and how the various scenarios are addressed. At 110, a received payment identifier, via a point-of-sale device for example, is checked against a first database to determine if the payment identifier is new or preexisting. If the payment identifier is new, scenario 1 is applicable and, at 120, a second database is checked for the status associated with a received user account. If the status is new, scenario 1.1 is executed at 130. If the status is pending, scenario 1.2 is executed at 140. If the status is registered, scenario 1.3 is executed at 150.

Returning to step 110, if it is determined that the payment identifier is preexisting, the status of a retrieved (from the first database and associated with the preexisting identifier) user account is checked against the second database at 160 to determine if it is pending or registered. If the status is pending, scenario 2.1 is executed at 170. If the status is registered, scenario 2.2 is executed at 180.

Scenario 1: The Payment Identifier is New, and the User Desires a Paperless Receipt

In some embodiments, the payment identifier is new to the system. A payment identifier can be classified as new when used by the user for the first time, such as when a user uses a new credit card that is not found in the database having records of payment identifiers. A payment identifier can also be classified as new if it is used again after a user previously declined to receive a paperless receipt when using the same payment identifier for a previous transaction, since, as described above, no database record of the payment identifier was previously created.

The user can request a paperless receipt during the transaction in any suitable manner. In some embodiments, upon determining that the payment identifier is new, the user is invited to receive paperless receipts, and optionally, to register for receiving loyalty discounts. In some embodiments, inviting the user to receive paperless receipts includes asking the user, via the point-of-sale device for example, for a unique user account to receive the paperless receipt of the transaction. The unique user account can be any account where the user can receive a paperless receipt, including, but not limited to, a cell phone number of the user, an email address of the user, a social media account of the user, and/or the like. In some embodiments, the unique user account is a cell phone number of a Smartphone of the user capable of receiving hyperlinked text messages.

In some embodiments, the record of the new payment identifier in the first database is created once the user provides the unique user account, and further includes the unique user account. In other words, each database record of a payment identifier includes a unique user account associated therewith. An exemplary, non-limiting format of such a database record, or ‘tuple’, of the first database is illustrated in Table 1 below, where additional field(s) are within the scope of the present disclosure and denoted as “Field n”.

TABLE 1

| Field 1 | Field 2 | Field 3 | Field n |
|---|---|---|---|
| Payment | User | Discount(s) #1 | Other |
| Identifier 1 | Account 1 | | information |
| Payment | User | Discount(s) #2 | Other |
| Identifier 2 | Account 2 | | information |
| Payment | User | Discount(s) #3 | Other |
| Identifier 3 | Account 2 | | information |

In this manner, when the user pays for a subsequent transaction with the same payment identifier (e.g. the same credit card), the unique user account is located in the database and the system determines that the user is a repeat user who benefited from receiving a paperless receipt for a previous transaction, without requiring additional information from the user.

As noted above, new and unrecorded payment identifiers can potentially belong to new, pending, or registered users; i.e., it is entirely possible for a pending/registered user to use a new payment identifier (e.g. a different credit card than the one stored in the database for the user's phone number). Each of these scenarios is explained in more detail below as scenarios 1.1, 1.2, and 1.3.

The systems and methods described herein are operable to employ a second database having records, each record specifying at least a) a payment identifier, b) a unique user account, and c) whether the user associated with the unique user account is pending or registered, i.e., a user status. In some embodiments, each record in the second database also specifies a discount associated with the payment identifier. A user is new when no record specifying the unique user account provided by the user exists in the second database. An exemplary, non-limiting format of such a database record, or ‘tuple’ is illustrated in Table 2 below, where additional field(s) are within the scope of the present disclosure and denoted as “Field n”.

TABLE 2

| Field 1 | Field 2 | Field 3 | Field 4 | Field n |
|---|---|---|---|---|
| Payment | User | User | Discount(s) #1 | Other |
| Identifier 1 | Account 1 | Status 1 | | information |
| Payment | User | User | Discount(s) #2 | Other |
| Identifier 2 | Account 2 | Status 2 | | information |
| Payment | User | User | Discount(s) #3 | Other |
| Identifier 3 | Account 2 | Status 2 | | information |

As best illustrated in Tables 1 and 2, it follows that, in some embodiments, each of the first and second databases has a single record for each unique payment identifier. Said another way, each payment identifier is associated with a single user account. It also follows that each of the first and second databases can have multiple records for each unique user account, since each unique user account can be associated with multiple payment identifiers. However, each user account has the same user status across all payment identifiers. Additionally, as illustrated in Table 2, each payment identifier can have discount information independent of other payment identifiers.

Scenario 1.1: When the Payment Identifier is New and the User Account is New.

In Scenario 1.1, no corresponding record exists in the first or second database for the payment identifier. In some embodiments, a record will be created in the first database specifying the new payment identifier and the new user account. Further, no corresponding record will exist in the second database, and the unique user account will be deemed to be new but requiring recordation into the second database as pending. In some embodiments, a record will be created in the second database specifying the new payment identifier, the unique user account, the user status as pending registration, and any discount. A paperless receipt can then be transmitted to the new user account.

In some embodiments, the new user account is a mobile number, and the paperless receipt sent to the mobile phone number also includes a registration link. When link is a web link and the user's phone is a Smartphone and/or otherwise web browser enabled, the user is able to directly click on the web link to provide registration information at her convenience.

In some embodiments, a counter is initiated and associated with each new user account or with each new payment identifier, and briefly explained here with respect to user accounts, for simplicity. The counter can be any suitable measure of how long a user can remain pending while receiving paperless receipts. In some embodiments, the counter is initiated at a predetermined or programmable threshold, and decremented for each transaction associated with the pending user account. In some embodiments, the counter is initiated at zero and incremented for each transaction associated with the pending user account up to a predetermined or programmable threshold, and decremented. In some embodiments, the counter is a timestamp of the transaction. Manipulation of the counter is described in more details in the scenarios that follow.

In some embodiments, the counter is part of each database record created in the second database for the pending user account (e.g. one of the ‘other information’ fields of Table 1 and/or Table 2). In some embodiments, the counter is stored elsewhere and is linked to the (pending) user account by any suitable means, as is known in the art.

Scenario 1.2: When the Payment Identifier is New and the User Account is Pending

When a pending user uses a new payment identifier (e.g. a different credit card) in a subsequent transaction but specifies a pending user account (e.g. the same cell phone number as a previous record in the second database with the user status specified as pending) when requesting a paperless receipt, a record is created in the first database for the new payment identifier and the pending user account. A lookup performed on the second database based on the pending user account yields the user status as already pending. Accordingly, a new record is created in the second database including the new payment identifier, the pending user account, the user status as pending, and any loyalty discount. A paperless receipt can then be transmitted to the pending user account.

In some embodiments, the loyalty discount associated with any payment identifier of the pending user account, or some combination thereof, can be applied to the subsequent transaction and reflected in the paperless receipt as being instantly applied. In some embodiments, the discount associated with any payment identifier of the pending user account is updated based on the subsequent transaction and reflected in the paperless receipt as available for future transactions.

In this manner, each payment identifier associated with the pending user account, despite being recorded separately in the second database, has the same user status at all times. Further, the discount applied to a current and/or subsequent transaction(s) can be consolidated across one or more payment identifiers associated with the user.

In some embodiments, the counter associated with the pending user account is incremented for each transaction by a pending user until it reaches a predetermined and/or programmable threshold. In some embodiments, the counter is decremented for each transaction by a pending user until it reaches zero. In some embodiments, the timestamp of the counter is updated with the timestamp of the latest transaction.

In some embodiments, the paperless receipt sent to the mobile phone number also includes a web link for registration. When the user's phone is a Smartphone and/or otherwise web browser enabled, the user is able to directly click on the web link to provide registration information at her convenience. In some embodiments, the paperless receipt includes an indication that the user will not receive anymore paperless receipts for subsequent transactions without registering.

In some embodiments, the user registers by providing identification information that includes at least the (first) pending user account, and a second user account. The pending user account can be used to link the registration information with the first and second databases, and to update all records in the second database having the pending user account to specify the user status as registered. In this manner, no matter which payment identifier the user uses in the future, she will be recognized as a registered user, and loyalty discounts can be accordingly applied.

The second user account can be any account suitable for receiving paperless receipts for future transactions. In some embodiments, the second user account is a social media account of the user, and the registration of the second user account is a permission from the user to post the paperless receipt to the social media account. In this manner, the user can broadcast her subsequent purchases, including discounts received, to her social media friends without having to provide additional information during purchase. Additionally, by building applied and earned discount and/or reward information into the paperless receipt viewable by the user's social media friends, the user and others are reminded of the benefits received (and/or of benefits available for future purchases) in real-time, and in a digitally persistent form. The merchant is also benefitted by the publicity. In some embodiments, upon registration, the user does not receive paperless receipts at the first user account anymore, or can opt out of receiving paperless receipts at the first user account.

Scenario 1.3: When the Payment Identifier is New and the Unique User Account is Registered

When a registered user uses a new payment identifier (e.g. a different credit card) in a subsequent transaction but specifies a registered user account (e.g. the same mobile number as a previous record in the second database with the user status specified as registered) when requesting a paperless receipt, a record is created in the first database for the new payment identifier and the registered user account. A lookup in the second database based on the registered user account yields the user status as already registered, a new record is created in the second database that includes the new payment identifier, the registered user account, the user status as registered, and any loyalty discount. A paperless receipt can be transmitted to the registered user account.

In some embodiments, the loyalty discount associated with any payment identifier of the same user account, or some combination thereof, can be applied to the subsequent transaction and reflected in the paperless receipt send to the second user account as being instantly applied. In some embodiments, the loyalty discount associated with any payment identifier of the same user account is updated based on the subsequent transaction and reflected in the paperless receipt send to the second user account as available for future transactions. In some embodiments, the loyalty discount is associated with the registration information of the user upon registration.

Scenario 2: The Payment Information is not New

In some embodiments, the payment identifier is preexisting, having been applied to at least one previous transaction for which the user requested a paperless receipt. A preexisting payment identifier is hence indicative of the user status being either pending or registered. A payment identifier can be classified as preexisting when a record exists in the first database that specifies the payment identifier and has a unique user account associated therewith. It follows that a record will also exist in the second database that specifies the payment identifier, the unique user account, a user status as pending or registered, and loyalty discount information. Scenarios 2.1 and 2.2 detail aspects of the invention when the user account is pending and registered, respectively.

Scenario 2.1: The Payment Identifier is not New and the User Account is Pending

When a pending user uses a preexisting payment identifier (e.g. a previously used credit card) in a subsequent transaction, a lookup in the first database based on the payment identifier automatically yields the unique user account associated therewith, while a lookup in the second database based on the unique user account automatically yields the user status as pending. A paperless receipt can be transmitted to the unique (pending) user account without further user input.

In some embodiments, the loyalty discount associated with the record of the preexisting payment identifier is applied to the subsequent transaction and reflected in the paperless receipt as being instantly applied. In other embodiments, the loyalty discount associated with the record of the payment identifier is not applied to the subsequent transaction, but reflected in the paperless receipt as being available once the user is registered. In some embodiments, the loyalty discount associated with the record of the payment identifier is updated based on the subsequent transaction and reflected in the paperless receipt as available for future transactions.

In some embodiments, the counter associated with the pending user account is incremented for each subsequent transaction by a pending user until it reaches a predetermined and/or programmable threshold. In some embodiments, the counter is decremented for each subsequent transaction by a pending user until it reaches zero. In some embodiments, the timestamp of the counter is updated.

In this manner, simply by using a preexisting payment identifier to pay for a transaction as is standard practice, a user can potentially receive a discount and receive a paperless receipt without further input.

Aspects of the invention are further operable to ensure that pending users that have not registered since the last transaction still wish to continue receiving paperless receipts. In some embodiments, instead of transmitting a paperless receipt to the pending user account without further input, the user is again queried if she wishes to receive a paperless receipt, via the point-of-sale device, for example. If the user indicates that she would like to continue receiving paperless receipts, the paperless receipt is sent to the pending user account, (e.g. a mobile phone number), and can also includes a web link for registration, as described above.

In some embodiments, the user declines to receive paperless receipts. In some embodiments, this results in one or more of the following: deletion of first and second database records corresponding to the preexisting payment identifier, deletion of first and second database records corresponding to the pending user account, and no action.

Scenario 2.2: The Payment Identifier is not New and the User Account is Registered

When a registered user (i.e. one who has registered and provided a second user account in the manner described above) uses the preexisting payment identifier in a subsequent transaction, a lookup in the first database based on the payment identifier automatically yields the corresponding (unique) user account, and a lookup in the second database based on the unique user account automatically yields the user status as registered. Further, a lookup of the registration information of the user based on the unique user account automatically yields the second user account, and a paperless receipt can be transmitted to the second user account and/or the registered user account without further user input.

In some embodiments, the loyalty discount associated with any payment identifier of the same user account, or some combination thereof, can be applied to the subsequent transaction and reflected in the paperless receipt send to the second user account as being instantly applied. In some embodiments, the loyalty discount associated with any payment identifier of the same user account is updated based on the subsequent transaction and reflected in the paperless receipt sent to the second user account as available for future transactions.

In this manner, simply by using a preexisting payment method (e.g., payment identifier associated with a particular credit card) to pay for a transaction as is standard practice, a registered user (and in some embodiments, a pending user) can receive a loyalty discount and a paperless receipt without further input.

Having described methods in which new users and/or method of payment can be registered for paperless receipts and real-time loyalty discounts, FIG. 2 illustrates an environment or system 200 within which aspects of the method can be implemented. The system 200 is operable for generating and delivering paperless receipts of a transaction. In some embodiments, the system 200 also determines and applies loyalty discounts to the transactions. In some embodiments, the system 200 is operable for use by a merchant 202 having an associated point of sale device 204 to deliver the receipt to a social media account (e.g. user account 212a) of the user (e.g. user 210) of the transaction when the user is registered, and to another account of the user (e.g. user account 212b) if the user is new or pending. Generally, the user 210 may be associated with additional user accounts as well (e.g. user account 212n).

In some embodiments, aspects of the system 200 can operate within the context of a transaction system that generates transaction information from separately received order information and payment information, as generally disclosed in U.S. Provisional Application No. 61/660,186 filed Jun. 15, 2012, titled “APPARATUS AND METHODS OF A TRANSACTION SYSTEM”, the disclosure of which is incorporated herein in its entirety. In some embodiments, aspects of the system 200 can operate within the context of a provider management system that facilitates user-driven, real-time selection between multiple payment providers, as generally disclosed in U.S. Provisional Application No. 61/693,566 filed Aug. 27, 2012, titled “APPARATUS AND METHODS OF A PROVIDER MANAGEMENT SYSTEM” the disclosure of which is incorporated herein in its entirety.

The system 200 includes a receipt system 208 and a payment system 206. The payment system 206 can optionally encompass or (as illustrated) be in communication with a payment processor 206′. The various components of the system 200 can be in communication as indicated by lines in FIG. 2 via a network, which may be any type of network (e.g., a local area network or LAN, a wide area network or WAN, a virtual network, a telecommunications network, and/or the internet) implemented as a wired network and/or a wireless network. Any or all communications may be secured (e.g., encrypted) or unsecured, as is known in the art. Each of the merchant 202, point-of-sale (PoS) 204, payment system 206, payment processor 206′, receipt system 208, and user 210 can include a personal computer, a server, a work station, a tablet, a mobile device, a cloud computing environment, an application or a module running on any of these platforms, and/or the like. Additionally, it is understood that merchant 202 and user 210 can be any suitably representative human entity, such as an actual person, an employee, and so on. Hence, user accounts 212a, 212b, 212n and so on might be that of a person depicted as user 210, and not necessarily tied to a device corresponding to the user 210.

In some embodiments, at least some aspects of the payment system 206 and the receipt system 208 are commonly implemented on the same device, and/or are commonly owned. In some embodiments, the payment processor 206′ is a third party service for executing payments.

In some embodiments, the flow of information between the various entities of the system 200 can be as follows, with reference to FIGS. 1 and 2. Payment information for a transaction by the user 210 is provided to the merchant 202, such as by providing a payment identifier (e.g. a credit card) to the point of sale 204 (e.g. a credit card reader) of the merchant. The payment system 206 receives the payment identifier from the point of sale 204, and executes step 110 to determine if it is new or preexisting, such as by accessing the first database described above. If the identifier is new and the user 210, upon a subsequent query, declines to receive a paperless receipt, the payment system 206 processes the payment information. In some embodiments, the payment system 206 passes the payment information to the payment processor 206′, which in turn processes the payment information.

If the payment identifier is new and the user 210 desires a paperless receipt, the payment system 206 executes the payment as described above, and further passes the payment information, including the payment identifier, to the receipt system 208. The receipt system 208 executes step 120 to determine if the user status of the user 210 is new, pending or registered, such as by accessing the second database described above. If the user 210 is new or pending, the receipt system executes step 130 or step 140, respectively, and transmits the receipt information to the payment system for transmittal to the user account 212b, along with a registration link. In this manner, even though the user has not yet registered user account 212a with the receipt system 208, she can still receive a paperless receipt. If the user 210 has is registered, the receipt system transmits the paperless receipt to the registered user account 212a. In some embodiments, the receipt system 208 also determines and transmits updated discount information to the payment system 206 for use in subsequent transactions with the same payment identifier and/or by the same user 210.

If the payment identifier is preexisting, the payment system 206 executes the payment as described above. The executed payment reflects any discount associated with the payment identifier and/or the pending/registered user account associated therewith, as can be determined by the payment system 206 by accessing the first database. The payment system 206 further passes the payment information, including the payment identifier, to the receipt system 208. The receipt system 208 executes step 160 to determine if the user status of the user 210 is pending or registered, such as by accessing the second database. If the user is pending, the receipt system executes step 170, and transmits the receipt information to the payment system 206 for transmittal to the user account 212b, along with a registration link. If the user is registered, the receipt system executes step 180, the receipt system transmits the paperless receipt to the registered user account 212a. In some embodiments, the receipt system 208 also determines and transmits updated discount information to the payment system 206 for use in subsequent transactions with the same payment identifier and/or by the same user 210.

FIG. 3 illustrates the payment system 206 according to some embodiments. The payment system 206 includes at least a processor 216 and a memory 218. The payment system 206 may additionally include a first database 220, although it is understood that the first database 220 can be outside the device/system context of the payment system 206 (yet within the system 200) while still accessible and usable by the payment system. In some embodiments, the memory 218 includes the first database 220.

Still referring to FIG. 3, the processor 216 can include a point of sale (PoS) module 222, a receipt module 224, a payment processing module 226, a token management module 228 and a user account module 230. The processor 216 can also include a database module 232 for reading and/or updating the first database 220. The processor 216 can also include a communications module 234 for establishing and managing network connectivity of the payment system 206 within the system 200.

The functionality of the various modules of the processor 216 can overlap, and/or two or more modules can be combined. For example, the PoS module 222 and the token management module 228 may be partly or wholly combined in some embodiments since both manipulate the payment identifier (e.g. a token). As another example, the receipt module 224 and the user account module 230 can be combined, since both can act in combination to deliver paperless receipts and registration links to pending users. Furthermore, each of the modules may be in seamless communication with each other module.

The PoS module 222 can be configured to receive the payment information and/or payment identifier information from the PoS 204. In some embodiments, the PoS module 222 is also configurable to interact with the PoS 204, when it is determined that the payment identifier is new (e.g. scenario 1.1), to ask if the user 210 desires a paperless receipt, and if so, to request and receive user account information to be associated with the new payment identifier. The PoS module 222 transmits the received payment identifier to the token management module 228.

The token management module 228 is configurable to receive the payment identifier from the PoS module 222, and to determine if the payment identifier is new or preexisting. The token management module 228 is further configurable for disposing a new payment identifier without storage if the user 210 does not want a paperless receipt. The token management module 228 is further configurable for determining user account information and any discount information associated with a preexisting payment identifier by accessing the first database 220 via the database module 232. The token management module 228 is further configurable for transmitting the payment information, including any discount information, to the payment processing module 226.

The payment processing module 226 can be configured to receive the payment information and any discount information from the token management module 228, and is configurable to execute the payment for the transaction after applying the discount information. In some embodiments, the payment processing module 226 communicates with the PoS 204 (e.g. via PoS module 222) to confirm that the user 210 intends to apply the discount information to the transaction. In some embodiments, the payment processing module 226 does not execute the payment but transmits the payment information to a third party entity such as the payment processor 206′, and receives confirmation or failure of the success of the transaction from the payment processor. The payment processing module 226 is further configurable for transmitting the processed payment information to the receipt module 224.

In some embodiments, the payment processing module 226 can be configured to suspend or hold the payment information prior to execution, and to send at least part of the suspended information to the receipt system 208 (via receipt module 224) for determining the latest loyalty and/or any discount information to be applied to the payment information, as described herein. The payment processing module 226 can be further configured to receive the latest discount information from the receipt module 224 and to apply the determined loyalty to the suspended transaction.

In some embodiments, the payment processing module 226 communicates with the PoS 204 (e.g. via PoS module 222) to confirm that the user 210 intends to apply the discount information to the suspended transaction. Applying the discount information may include, but is not limited to, one or more of providing a reward to the user, applying a discount to the transaction that alters an amount of a payment associated with the transaction, and/or the like. After applying the discount information, the payment processing module 226 may release the suspended transaction for processing in any suitable manner, including executing or transmitting the transaction information as described above.

The receipt module 224 receives the processed and/or suspended payment information from the payment processing module 226, and is configurable to transmit the payment information to the receipt system 208. In embodiments where the payment information is suspended by the payment processing module 226, the receipt module 224 is further configurable to transmit the suspended payment information to the receipt system 208 and in response, to receive the latest discount information from the receipt system 208 for applying to the suspended transaction. The receipt module 224 is also configurable to receive from the receipt system 208 an indication of whether to transmit a paperless receipt to the user account 212a, which can be the case when the receipt system 208 determines that the user 210 is pending registration (e.g. scenario 1.2 and 2.1). When the receipt module 224 generates a paperless receipt for transmission to the user account 212a, it can include a registration link for the user 210 as described earlier. The receipt module 224 is further configurable to transmit the paperless receipt and registration link to the pending user account 212a via the user account module 230.

The receipt module 224 is further configurable to receive updated discount information from the receipt system 208, and to transmit the updated discount information to the token management module 228, which in turn updates the first database 220 with the updated discount information. The receipt module 224 is further configurable for interacting with the token management module 228 to update and/or delete payment identifier information in the first database 220 when a pending user declines paperless receipts (e.g. scenario 2.1).

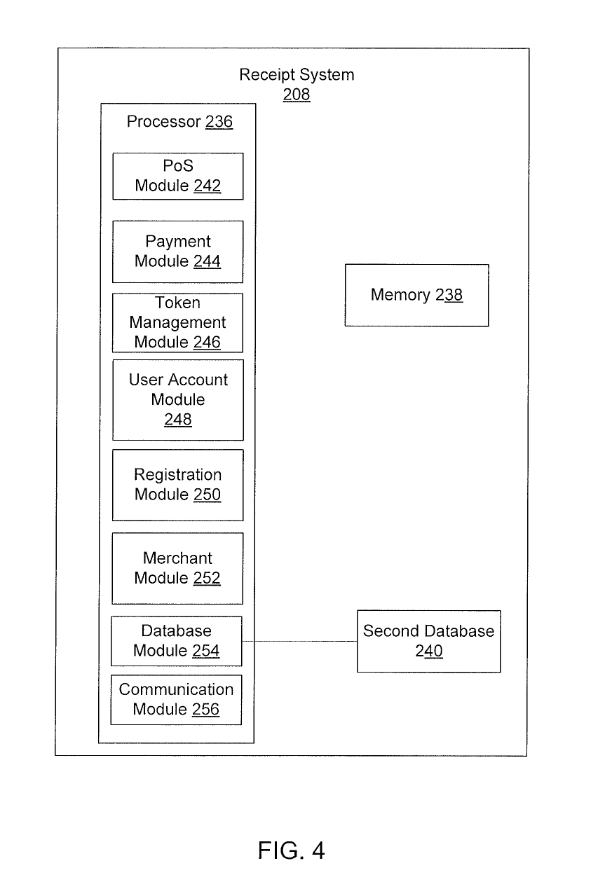

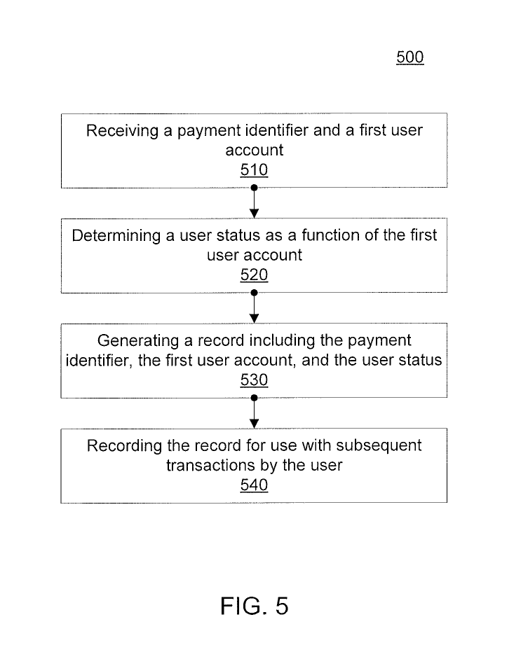

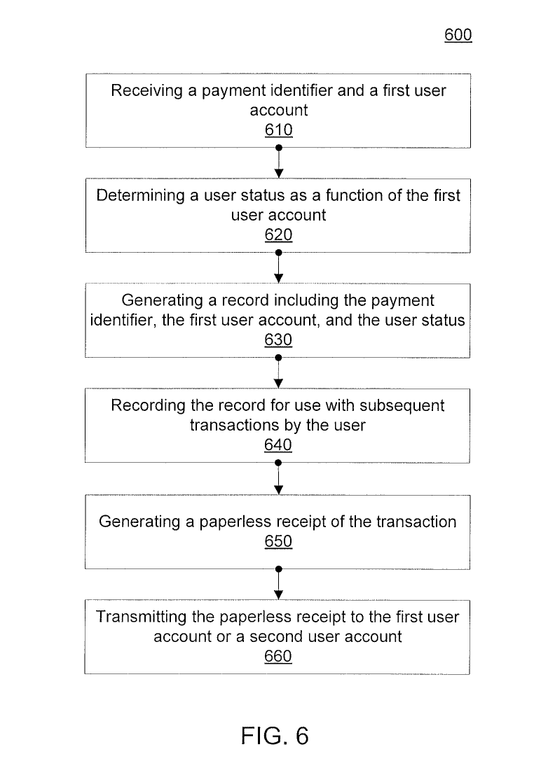

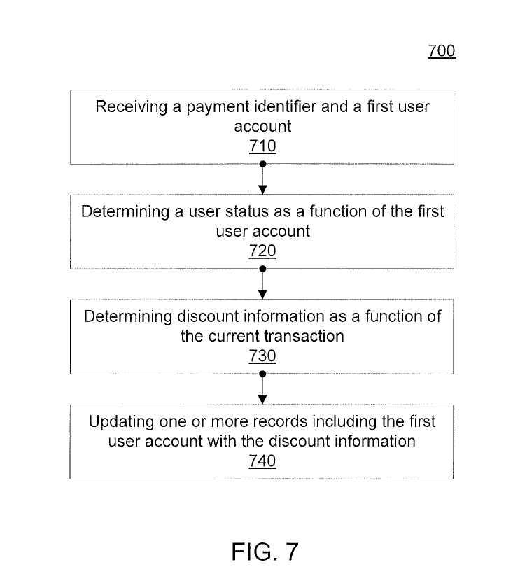

FIG. 4 illustrates the receipt system 208 according to some embodiments. The receipt system 208 includes at least a processor 236 and a memory 238. The receipt system 208 may additionally encompass a second database 240, although it is understood that the second database 240 can be outside the device/system context of the receipt system 208 (yet within the system 200) while still accessible and usable by the receipt system. In some embodiments, the memory 238 includes the second database 240.

The processor 236 can include a point of sale (PoS) module 242, a payment module 244, a token management module 246, a user account module 248, a registration module 250, and a merchant module 252. The processor 236 can also include a database module 254 for reading and/or updating the second database 220. The processor 236 can also include a communications module 254 for establishing and managing network connectivity of the receipt system 208 within the system 200. The functionality of the various modules of the processor 236 can overlap, and/or two or more modules can be combined. Furthermore, each of the modules may be in seamless communication with each other module.

The PoS module 242 of the receipt system 208 is configurable to receive data directly from the PoS 204 and/or from the merchant 202, as best illustrated in FIG. 1. In this manner, the receipt system 208 can receive less sensitive transaction information from the merchant directly from the PoS 204, and relatively more sensitive information such as payment information via the payment system 206. Examples of less sensitive transaction information include, but is not limited to, a stock keeping unit (SKU), and/or the like. In some embodiments, the PoS module 242 communicates transaction and non-transaction related information to the PoS 204, such as advertisements, registration information, product ratings, and/or the like. In some embodiments, the PoS module 242 and the receipt system 206 are commonly owned or otherwise permitted to directly communicate as described here. In other embodiments, the PoS 204 is a third party device with respect to the receipt system 206, and cannot communicate with the receipt system. Hence, the PoS module 242 can be optional.

The payment module 244 is configurable to receive the payment identifier and other transaction-based information from the payment system 206. The payment module 244 is also configurable to communicate the received information to the token management module 246. The payment module 244 is further configurable to communicate an indication to the payment system 206 of whether the user 210 is pending or registered. Said another way, the payment module 244 communicates to the payment system 206 whether to transmit a paperless receipt and registration link to the pending user account 212a (for pending users, see scenarios 1.1, 1.2, 2.1), or whether the receipt system 208 will deliver a paperless receipt to the registered user account 212b. The payment module 244 is further configured to communicate the payment information and any other transaction-related information (e.g. received from the PoS module 242) to the merchant module 252 for determining discount information, as discussed in more detail below.

The token management module 246 is configurable to receive the payment information and/or identifier from the payment module 244, and to determine if the user status of the user 210 is new, pending, or registered by accessing the second database 240 via the database module 254. The token management module 246 is further configurable for generating a new record in the second database 240 if the user status of the user 210 is new (see scenario 1.1). The token management module 246 can also communicate with the merchant module 252 to receive updated discount information to be associated with the payment identifier and/or the user 210 in the second database 240.

The merchant module 252 is configurable to receive the transaction information, including payment information, from the payment module 244. The merchant module 252 is further configurable to determine discount information based on, among other factors, the received transaction information. Determining discount information may refer to, but is not limited to, one or more of: determining a reward to be provided to the user 210, determining a discount that alters the amount of the transaction, tracking the user's purchasing habits, updating the customer's purchasing habits in a database (not shown), checking a campaign of the merchant (e.g. a customer loyalty campaign) for available discounts and/or offers that can be applied to the transaction and/or to future transactions based on the transaction, checking a social media profile of the user 210, checking for the user's loyalty to the merchant against a social media profile of the customer, and/or the like. The determined discount information may be communicated to the payment system 206 (e.g. via the payment module 244) and optionally, to the PoS 204 (e.g. via the PoS module 242). In some embodiments, the merchant module 252 updates a registered social media account (e.g. the user account 212b) of the user 210 to reflect the determined discount information, and optionally communicates the discount information to other accounts (e.g. the user accounts 212a, 212n) of the user. In some embodiments, the loyalty system 150 updates a transaction database (not shown) with the determined discount and any other relevant transaction information.

In some embodiments, the merchant module 252 enables the merchant 202 to set up a merchant profile that specifies how a user of the merchant (e.g. the user 210) may earn discounts for purchases. The merchant profile may be accessible to the merchant 202 upon providing relevant identifying credentials, as is known in the arts. The merchant module 252 may additionally permit a merchant to view any relevant data of current and/or past transactions by accessing the second database 240. In some embodiments, the merchant module 252 is configurable to provide offerings, merchant-specific messages, and other information to the PoS module 242 for display on the PoS 204. In some embodiments, the merchant module 252 permits the registered merchant 202 to view user ratings and other user-specific information by accessing the user's registered account. The user data presented to the merchant 202 can be filtered or otherwise anonymized to remove personally identifiable data.

The registration module 250 is operable to receive user registration information and convert pending users to registered users. As described earlier, whenever a pending user (e.g. the user 210) receives a paperless receipt, she also receives a registration link (see scenarios 1.2, 2.1). The user 210 at her own convenience can then provide the registration data to the receipt system 208 as illustrated in FIG. 2, and more particularly, to the registration module 250. In some embodiments, the registration data includes the specification of both the pending user account 212a, and the user account 212b specified as a registered account for receiving paperless receipts of subsequent transactions. The registration data can be stored in the second database 240 separate from the payment identifier-based records illustrated in Table 2. The registration module 250 is also operable to update the second database 240 to specify the user status of the user 210 as registered for all payment identifiers associated with the user 210.

The user account module 248 is configurable to manage the registration data of registered users. In some embodiments, the user account module 248 is further configurable for enabling the user 210 to login and manage her registered account, including viewing special merchant offerings, transaction history, discounts earned/pending, adding or removing her registered payment identifiers, and/or the like. In some embodiments, the user account module 248 is configurable to transmit the paperless receipt to the registered user account 212b.

As stated earlier, embodiments described herein are driven by transaction-based recordation of new payment identifiers in the first and second databases. FIG. 5 illustrates a method 500 of transaction-based recordation of a new payment identifier, and is described with reference to FIGS. 1-4. At 510, a payment identifier and a first user account associated with the payment identifier are received, where the payment identifier and the first user account are associated with a transaction by the user 210 at the PoS 204 of the merchant 202. The payment identifier can be a credit/debit/gift card number, bank account information, virtual currency, and/or the like. The first user account can be selected from a cell phone number of the user 210, an email address of the user 210, and/or the like.

At 520, a user status associated with the user 210 is determined as a function of the first user account. The user status is one of new, pending, and registered. In some embodiments, the user status is determined as pending or registered by searching previous records in the second database 240 for the first user account, and at least one previous record includes the first user account. In some embodiments, the user status is determined as new when no previous record in the second database 240 includes the first user account.

At 530, a record is generated that includes the payment identifier, the first user account, and the user status, where the user status of the record is set to be the same as a user status of the at least one previous record. At 540, the generated record is stored in the second database 240 for use with subsequent transactions by the user 210.

In some embodiments, if the user status is registered, the method 500 further includes transmitting a paperless receipt of the transaction to a second user account associated with registration information of the user. The second user account (e.g. the user account 212b) can be the same as or different from the first user account (e.g. the user account 212a). In some embodiments, the second user account is a social media account of the user.

In some embodiments, if the user status is new or pending, the method 500 further includes transmitting a paperless receipt of the transaction to the first user account. In some embodiments, a registration request also transmitted to the first user account, and registration information is received from the user. The registration information can include the first user account and the second user account. In some embodiments, upon registration, the user status for all records in the second database that include the first user account are changed to registered.

In some embodiments, the payment identifier is generated as a function of payment information associated with the transaction. A first record that includes the payment identifier and the first user account is generated and recorded in the first database 220 for use with subsequent transactions by the user 210. In some embodiments, the first record does not include the user status. In some embodiments, the payment-identifier based records in the first and second databases (see Tables 1 and 2 for exemplary formats of the records in each of these databases) are synchronized based on the payment identifier.

FIG. 6 illustrates a method 600 of providing a recorded user account (i.e. a pending or registered user account) with a paperless receipt, according to additional embodiments. At 610, a payment identifier and a first user account associated therewith are received, and can be associated with a transaction by the user 210 at the merchant 202. At 620, a second user status is determined that is associated with a user of the first user account, such as in one or more record(s) in the second database 240. At 630, a second record is generated that includes the payment identifier, the first user account, and the second user status. The second record is recording in the second database 240 for use with subsequent transactions by the user 210 at 640.

At 650, a paperless receipt of the transaction is generated as a function of the second user status of the user. In other words, as described earlier, the paperless receipt is generated by the payment system 206 if the second user status is pending and can include a registration link, and is generated by the receipt system if the second user status is registered. At 660, the paperless receipt is transmitted to the first (pending) user account and/or a second (registered) user account of the user as a function of the second user status of the user.

In some embodiments, the second record includes a timeout value or counter. The timeout value can be any suitable measure of how long a user can remain pending while receiving paperless receipts. In some embodiments, the timeout value is initiated at a predetermined or programmable threshold, and decremented for each transaction associated with the pending user account. In some embodiments, the timeout value is initiated at zero and incremented for each transaction associated with the pending user account upto a predetermined or programmable threshold, and decremented. In some embodiments, the timeout value is a timestamp of the transaction.

In some embodiments, when the second user status is pending and the user does not desire a paperless receipt, the method 600 is further operable to perform one or more of the following: deletion of first and second database records corresponding to the payment identifier, deletion of first and second database records corresponding to the pending user account, and no action.

FIG. 7 illustrates a method 700 of transaction-based recordation of discount information for a recorded user account (i.e. a pending or registered user account), according to additional embodiments. At 710, a payment identifier and a first user account associated with the payment identifier is received for a transaction. At 720, a user status of the user 210 is determined as pending or registered. At 730, discount information is determined based at least on the current transaction. In some embodiments, the determined discount information is further a function of merchant information. At 740, one or more records that include the first user account are updated with the discount information for use in one or more subsequent transactions by the user 210.

In some embodiments, the payment identifier is generated as a function of the payment information, such as the generation of a token from credit card information, as is known in the arts. The method 700 can further include searching records in the second database 240 for the generated payment identifier, where at least one record is found that includes the payment identifier. The loyalty discount is retrieved from the at least one record (see Table 2), and can applied to the payment information, depending on whether the user is pending or registered. The payment information having the loyalty discount applied thereto can then be processed by the payment system 206 and/or the payment processor 206′ to complete payment for the transaction.

In some embodiments, depending on whether the user is pending or registered, the loyalty discount of at least one record in the second database 240 that includes the payment identifier is updated for use with subsequent transactions by the user 210. A paperless receipt can then be transmitted to either the (pending) first user account and/or the (registered) second user account that can include the payment information having the loyalty discount applied thereto, and can additionally include a specification of the determined discount information for subsequent transactions by the user 210.

Aspects of the system and methods described herein are hence beneficial from a merchant's perspective since it permits flexibility in rewarding customers of all levels of loyalty (first-time users, repeat non-registered users, pending users, registered users) and on any time frame possible, including instantaneously. For example, a first-time user can instantly be provided a discount on their first purchase without registering, and receive a receipt that promises future rewards. As another example, a repeat user that fails and/or refuses to register can still be recognized (e.g. is she uses the same credit card), and rewarded with a discount after ten purchases, and further receive a receipt indicating that she could have received twice the discount if she was registered. As yet another example, a registered user can receive an additional discount for a purchase made on her birthday and/or anniversary without the need to present a coupon.

Further, users feel encouraged to register with the merchant since there is no additional burden on the user to instantaneously reap the discount benefits of registration. Even if the user does not register, she can still benefit from giving the merchant repeated business and receiving a smaller discount than registered users, as described above. With the advent of social media, users are more prone to indulge in conspicuous consumption, and aspects of the system and methods described herein permit the user to effortlessly broadcast information about a purchase with no added effort to making a payment as usual. Merchants are instantaneously benefitted by the user's broadcast, which can result in short-term advertising and influence purchasing by the user's social circles, something critical for products with a short shelf life (e.g. a trending fashion accessory for the winter season).

### Example 1

In a non-limiting example to illustrate operation of the system 200, the merchant 202 may create a merchant profile via the merchant module 252 of the receipt system 208. The merchant 202 can specify discount information, which can include target demographics of users, condition(s) for applying a discount to a targeted user and/or group(s) of users, the duration for which the discount is valid, the nature of the discount, and/or the like.

During operation, when the user 210 makes a purchase, the payment information is transmitted from the PoS 204 to the payment system 206, which can suspend the payment information and communicate with the receipt system 208 to determine any applicable discount information. If there is no applicable discount information for the transaction, the payment system 206 proceeds with processing the transaction and payment. If the receipt system 208 determines that discount information is applicable, the receipt system transmits the discount information to the payment system 206, which applies it to the amount of the suspended payment information/transaction. The payment system 206 can then authorize the discounted transaction to be carried out by a bank server, such as the payment processor 206′, for example. The receipt system 208 and/or the payment system 206 can also notify the user 210 of the discount applied via the PoS 204, and/or via one of the user accounts 212a, 212b, 212n as applicable. The merchant module 252 can then update the merchant profile of the merchant 202 to reflect the awarded discount, and the database module 254 can then update the second database 240 with updated discount information.

### Example 2

In a second non-limiting example to illustrate operation of the system 200, a registered user (e.g. the user 210) can pay for the purchase with a credit card, and additional identification information is not required since the credit card number serves to uniquely identify the user as registered. When the credit card is swiped at the PoS 204, the transaction information is transmitted to the payment system 206, which suspends the payment information and communicates with the receipt system 208 to determine any applicable discounts. In this exemplary embodiment, the user's registration data/profile includes social media credentials that enable the receipt system 208 to interact with one or more social media accounts of the user 210 associated with the transaction. The social media credentials (also referred to as “digital persona”) can be for identification and/or access to any type of online medium, including, but not limited to, an internet web site, online forum, blog, podcast, message and bulletin board, social bookmarking website or similar forum, that is used to communicate or post data, writings, recordings or any other type of electronic information.

In this example, then, the receipt system 208 can be configured to apply more specific discount information based on demographic and/or other particular user information accessible via the user's social media profile(s). Merchants are hence benefitted by having access to such online social behavior information since they can more narrowly tailor their loyalty campaigns/discount programs to target individuals that are already loyal customers, are more likely to become repeat customers, are more likely to refer additional customers (e.g. based on ‘Friends’ of the user 210 and/or ‘Groups’ the user belongs to, etc.).

Some embodiments described herein relate to a computer storage product with a non-transitory computer-readable medium (also referred to as a non-transitory processor-readable medium) having instructions or computer code thereon for performing various computer-implemented operations. The computer-readable medium (or processor-readable medium) is non-transitory in the sense that it does not include transitory propagating signals (e.g., a propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages and/or other development tools.

The various embodiments described herein should not to be construed as limiting this disclosure in scope or spirit. It is to be understood that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

Those skilled in the art will recognize, or be able to ascertain, using no more than routine experimentation, numerous equivalents to the specific embodiments described specifically herein. Such equivalents are intended to be encompassed in the scope of the following claims.

1. A method of transaction-based recordation of a new payment identifier, comprising:
receiving a payment identifier and a first user account associated with the payment identifier, the payment identifier and the first user account associated with a transaction;
determining a user status as a function of the first user account, the user status associated with a user of the first user account;
generating a record including the payment identifier, the first user account, and the user status; and
recording the record for use with subsequent transactions by the user.

2. The method of claim 1, wherein the payment identifier is at least one of a credit card number, a debit card number, a gift card number, and bank account information.

3. The method of claim 1, wherein the first user account is selected from a cell phone number, an email address, and a social media account.

4. The method of claim 1, wherein the user status is selected from new, pending, and registered.

5. The method of claim 1, wherein determining the user status further comprises:
searching previous records for the first user account;
receiving at least one previous record that includes the first user account; and
determining the user status of the record to be the same as a user status of the at least one record,
wherein the user status of the at least one previous record is pending or registered.

6. The method of claim 1, wherein determining the user status further comprises:
searching previous records for the first user account; and
determining, when no previous record includes the first user account, the user status of the record to be pending.

7-12. (canceled)

13. The method of claim 1, wherein the record is a second record, the method further comprising:
generating the payment identifier as a function of payment information associated with the transaction;
receiving a specification of the first user account associated with the payment identifier;
generating a first record including the payment identifier and the first user account; and
recording the first record for use with subsequent transactions by the user.

14. The method of claim 13, wherein the first record does not include the user status, wherein the first record is recorded in a first database, and wherein the second record is recorded in a second database different from the first database.

15. The method of claim 14, further comprising synchronizing the records of the first database and the records of the second database based on the payment identifier.

16. The method of claim 13, further comprising processing the payment information to complete payment for the transaction.

17. A method of providing a recorded user account with a paperless receipt, comprising:
receiving a payment identifier and a first user account associated with the payment identifier, the payment identifier and the first user account associated with a transaction;
determining a user status as a function of the first user account, the user status associated with a user of the first user account;
generating a record including the payment identifier, the first user account, and the user status; and
recording the record for use with subsequent transactions by the user.
generating a paperless receipt of the transaction as a function of the user status of the user; and
transmitting the paperless receipt to the first user account or a second user account of the user as a function of the second user status of the user.

18-20. (canceled)

21. The method of claim 17, wherein the user status is a second user status, wherein the record is a second record, wherein determining the second user status further comprises:
searching previous records for the first user account;
receiving, at least one previous record that includes the first user account; and
determining the second user status of the second record to be the same as a user status of the at least one record,
wherein the user status of the at least one previous record is pending or registered.

22. The method of claim 17, wherein the user status is registered, wherein the paperless receipt is transmitted to the second user account, and wherein the second user account is associated with registration information of the user.

23. The method of claim 22, wherein the second user account is different from the first user account, and wherein the second user account is a social media account of the user.

24. The method of claim 17, wherein the user status is pending, and wherein the paperless receipt is transmitted to the first user account.

25. The method of claim 24, further comprising transmitting a registration request to the first user account of the user.

26. The method of claim 25, further comprising:
receiving, in response to the registration request, registration information from the user, the registration information comprising the first user account and the second user account; and
updating the user status to registered for all records including the first user account.

27-32. (canceled)

33. A method of transaction-based recordation of discount information for a recorded user account, comprising:
receiving a payment identifier and a first user account associated with the payment identifier, the payment identifier and the first user account associated with a current transaction;
determining a user status as a function of the first user account, the user status associated with a user of the first user account;
determining discount information as a function of the current transaction; and
updating one or more records including the first user account with the discount information for use in one or more subsequent transactions by the user.

34. The method of claim 33, further comprising:
receiving payment information associated with the transaction;
generating the payment identifier as a function of the payment information;
searching records of payment identifiers for the generated payment identifier, wherein at least one record is found including the generated payment identifier;
retrieving a loyalty discount from the at least one record; and
applying the loyalty discount to the payment information as a function of the user status.

35. The method of claim 34, further comprising processing the payment information having the loyalty discount applied thereto to complete payment for the transaction.

36. The method of claim 35, further comprising updating, as a function of the user status, the loyalty discount of at least one record including the payment identifier with the determined discount information for use with subsequent transactions by the user.

37. The method of claim 33, further comprising transmitting to the first user account or a second user account a paperless receipt of the transaction including the payment information having the loyalty discount applied thereto.

38. The method of claim 37, wherein the paperless receipt further comprises a specification of the determined discount information for subsequent transactions by the user.

39. The method of claim 33, further comprising receiving merchant information, wherein the determining discount information is further a function of the merchant information.

40-44. (canceled)
